(19) United States
(12) Patent Application Publication
(10) Pub. No.: US 2024/0001377 A1
(43) Pub. Date: Jan. 4, 2024

(54) WATER SAVING NOZZLE AND SHOWER HEAD COMPRISING SUCH NOZZLE

(71) Applicant: ALTERED STOCKHOLM AB, Stockholm (SE)

(72) Inventors: Lennart LINDGREN, Älvsjö (SE); Kaj Verner MICKOS, Nacka (SE)

(21) Appl. No.: 18/039,265

(22) PCT Filed: Nov. 25, 2021
(86) PCT No.: PCT/SE2021/051176

§ 371 Date: May 29, 2023

(30) Foreign Application Priority Data
Nov. 30, 2020 (SE) 2051390-9

(51) Int. Cl. B05B 1/06; E03C 1/04

(52) U.S. Cl. CPC B05B 1/06; E03C 1/0408

(57) ABSTRACT

A water saving nozzle having an inner chamber and an inner discharge opening and an outer chamber with several outer discharge openings, the outer chamber surrounding the inner chamber, the inner chamber comprises a water rotating device. Water discharged from the inner discharge opening is forming a dome and water discharged from the outer discharge openings are forming a spray surrounding the dome shape from the inner discharge opening. A shower head, comprising said nozzle having a first pipe feeding water to the inner chamber and a second pipe feeding water to the outer chamber. The second pipe having a stop for closing/opening the flow towards the outer chamber, providing a first mode giving a dome shaped water discharge when the stop is in a closed position, and a second mode giving a combined dome and spray water discharge when the stop is in an open position.

The present invention concerns a water saving nozzle, preferably for showers, and a shower head comprising such a water saving nozzle. The water saving nozzle comprises a housing having an inner chamber with an inner inlet opening for water to enter the inner chamber in a first end and an inner discharge opening for water leaving the inner chamber in a second end and the housing having an outer chamber with an outer inlet opening for water to enter the outer chamber in a first end and several outer discharge openings for water leaving the outer chamber in a second end, the outer chamber surrounding the inner chamber.

An important aim for the world is to household with water. Previously known nozzles, especially for showers, tend to use a lot of water. They are usually provided with a spray shaped discharge of the water. It is also known nozzles providing a mist, which will lower the water flow considerably. However, there is a problem to keep up the temperature in a mist and thus it requires a higher temperature of the water in the system. The mist also tends to flow in undesirable directions. Perhaps, the closest known art is a previous invention of the same proprietor showing a water saving nozzle providing an inner and an outer dome shaped discharge of water described in WO2019195043.

The present invention aims to provide water saving nozzle, preferably for showers, which will give an even better shower experience while still saving water, and a shower head comprising such a nozzle.

This is accomplished with a water saving nozzle according a first aspect of the present invention comprising a housing having an inner chamber with an inner inlet opening for water to enter the inner chamber in a first end and an inner discharge opening for water leaving the inner chamber in a second end. The inner chamber having a central length axis going between the first end and the second end. The nozzle also comprises an outer chamber with an outer inlet opening for water to enter the outer chamber in a first end and several outer discharge openings for water leaving the outer chamber in a second end. The outer chamber surrounds the inner chamber, around the central axis thereof. The inner chamber comprises a water rotating device. Water is flowable through the inner inlet, through the inner chamber, through the water rotating device and through the inner discharge opening, being centrally provided, forming a dome shape of the discharged water. Water may also flow through the outer inlet, through the outer chamber and out through the several outer discharge openings provided around the inner discharge opening, forming a spray of water surrounding the dome shape from the inner discharge opening.

According to an embodiment, a first flow regulator is in fluid contact with the inner chamber and a second flow regulator is in fluid connection with the outer chamber. This will stabilise the function of the water discharge.

According to an embodiment, the outer discharge openings are directed so that the spray will touch an outer of diameter of the dome shaped water from the inner discharge opening. When the outer spray touches and integrates with the inner dome a comfortable shower experience is provided.

According to a second aspect of the present invention a shower head comprising a water saving nozzle is provided. The shower head has a first pipe feeding water to the inner chamber from a water system and a second pipe feeding water to the outer chamber from the water system. The second pipe is provided with a stop device for closing and opening of the flow of water through the second pipe towards the outer chamber. This provides the possibility of having a first mode giving a dome shaped water discharge when the stop device is in a closed position, thus closing the second pipe, and a second mode giving a combined dome and spray water discharge when the stop device is in an open position, thus opening the second pipe. In the first mode a shower experience is provided which uses very little water, for example, as little as 1 gallon/minute (3.8 l/min). In the second mode a more intense shower experience is provided, suitable for, for example, rinsing shampoo from the hair.

According to an embodiment, the stop device is a valve comprising a valve chamber in fluid connection with a second portion of the second pipe downstream the valve, a valve plunge comprising a valve rod, and a cavity, on the opposite side of the valve plunge to the valve chamber. The valve comprises a spring for keeping the valve in a closed position, where the valve plunge stops any flow towards the outer chamber.

According to an embodiment, the valve is toggled between the two modes via a switch button connected to the valve rod for movement of the valve plunge.

According to an embodiment, the valve in the second mode is in an open position letting water to flow from a first portion of the second pipe into the valve chamber and further to the outer chamber.

According to an embodiment, a slit is provided between a first portion of the second pipe and the cavity so that a leakage of water will enter the cavity when the valve is in the first mode, i.e. in the closed position, giving a rise in water pressure in the cavity further keeping the valve plunge in closed position.

According to an embodiment, the second flow regulator is arranged downstream the valve in the second portion of the second pipe so that when the valve is in the open position a pressure is built up in the valve chamber keeping the valve plunge in the open position.

According to an embodiment, a fluid connection is provided between the cavity and a second portion of the first pipe, wherein the second portion runs between the first regulator and the inner chamber. This will lower the pressure in the cavity and thus create a suction force which will further help the valve plunge to stay in an open position.

### SHORT DESCRIPTION OF THE DRAWINGS

The present invention will now be described in more detail under referral to the enclosed drawings, in which:

FIG. 1 shows a dome of water discharged from an embodiment of a water saving nozzle.

FIG. 2 shows a spray of water and a dome of water discharged from an embodiment of a water saving nozzle.

FIG. 3 shows an embodiment of a water saving nozzle in a break-away view.

FIG. 4a, b shows different embodiments of outer discharge openings in cross-sectional view.

FIG. 5 shows an embodiment of a shower head comprising an embodiment of a water saving nozzle in a first mode of use giving a dome shaped water discharge, in a break-away view.

FIG. 6 shows the embodiment of FIG. 5 in a second mode of use giving a combined spray and dome shaped water discharge, in a break-away view.

### DETAILED DESCRIPTION

The present invention will be described by exemplifying embodiments. The flow of the water will be followed in order to explain details and features of embodiments of a water saving nozzle. Thereafter, the water will be followed through embodiments of a shower head up to the water saving nozzle. All features described are not necessary to provide the invention and the invention is only limited in accordance with the appended claims.

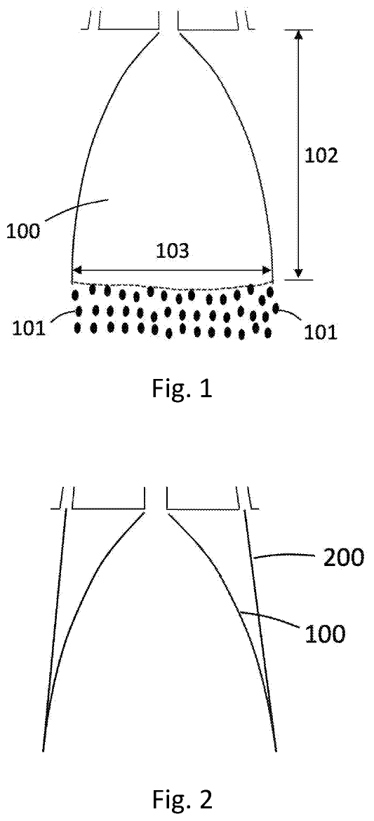

But first, the aim is to provide a proper shower experience which saves water at the same time. Out of an inner discharge opening a dome 100 of water will emerge. See FIG. 1. The dome 100 is preferably between 5-30 cm long if the water saving nozzle 1 is provided in a shower handle, but can be longer if the water saving nozzle is provided in a fixed shower head provided above a person to take a shower or shorter if the nozzle is used in a tap at a sink or handbasin. The dome 100 has an outer diameter 103 measured at the largest diameter. The dome 100 splits up in droplets 101 after the length 102 of the dome 100 and thus it is preferred that the water stays in a composed shape of a dome 100 until it reaches the body of a person taking a shower. Then it will give a feeling of a lot of water running over the body even if the flow is really low, preferably as low as around 3.5-4 l/min. The dome 100 is made up by a swirling, mainly laminar flow of water.

From several outer discharge openings surrounding the inner discharge opening a spray 200 may be delivered. See FIG. 2. Preferably, the spray 200 is arranged to touch the outer diameter of the dome 100 in order to integrate with the dome 100 and thus boost the shower with a higher flow of water without changing the overall experience of the shower.

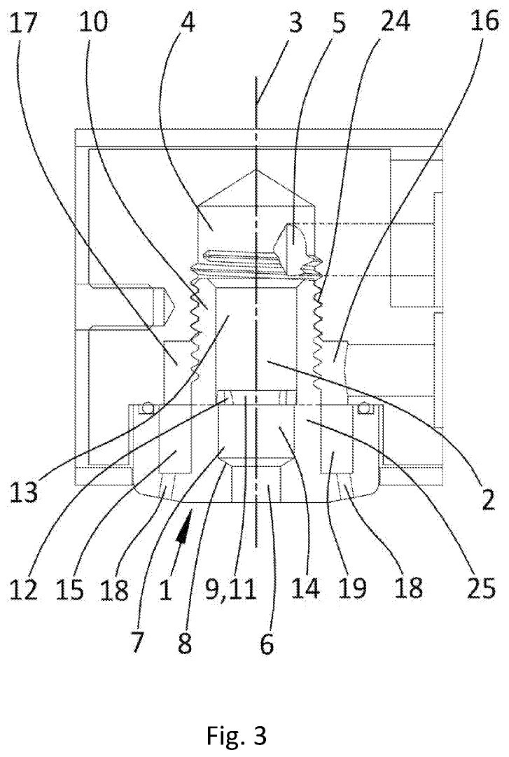

In FIG. 3 an embodiment of a water saving nozzle 1 comprises a housing 10 having an inner chamber 2. A central axis 3 is directed in its length direction. Preferably, the inner chamber 2 is basically cylindrical in shape around the central axis 3. In a first end 4 of the chamber 2 an inner inlet opening 5 for water to enter is provided. The inner inlet opening 5 may be provided at the top or in the vicinity of the top of the chamber 2. The water may enter in a direction parallel to the central axis 3 or, for example, orthogonally to the central axis 3. In case the water comes in parallel to the central axis 3 it could be in line with the central axis 3 or displaced from the central axis 3. In case the water comes in orthogonally to the central axis 3 it may enter radially or displaced, in a more tangential manner. In the latter case a rotation of the inflowing water may occur in the first end 4 of the inner chamber 2. It is also possible to arrange the incoming water in other angles.

An inner discharge opening 6 is arranged in a second end 7 of the inner chamber 2. The inner discharge opening 6 is arranged concentrically with the central axis 3. Preferably a slanted inner surface 8 provides a transition between the inner chamber 2 and the inner discharge opening 6 in the second end 7 if the cross-sectional area of the inner discharge opening 6 is less than the cross-sectional area of the inner chamber 2. The inner discharge opening 6 is preferably cylindrical around the central axis 3.

In the inner chamber 2, between the inner inlet opening 4 and the inner outlet discharge opening 6, a water rotating device 9 is positioned. It could be a vortex screw having threads at an inner surface along a portion of the length of the inner chamber 2 (not shown). But preferably it is a swirl plate 11 having a diameter corresponding to an inner diameter of the inner chamber 2 and a thickness, through which several throughgoing slots or holes 12 are present. The throughgoing slots or holes 12 are angled so that the water coming from a first portion 13 of the inner chamber 2 is directed into a rotation in a second portion 14 of the inner chamber 2. The rotating water will discharge through the inner discharge opening 6 in a further rotation building up the dome 100 of mainly laminar flow.

There are many parameters that decide the hollow dome shape 100 such as the water pressure, water flow, periphery velocity in the second portion 14 of the inner chamber 2, the design and position along the central axis 3 of the water rotating device 9, size of discharge opening and so on. The smaller the inner chamber 2 the smaller diameter of the dome 100 will be. Thus, increasing the size of the inner chamber 2 will increase the diameter of the dome 100. The longer the inner discharge opening 6 is the smaller the diameter of the dome 100 will be. If the inner discharge opening 6 is too small a mist or uncontrolled discharge of the water will occur. Thus, all the parameters must be in harmony in order to form the dome 100.

Thus, it is preferred to have a first flow regulator 20 in fluid connection with the inner inlet opening 5 in order to regulate the flow and pressure in the inner chamber 2 and thus safeguard a desired shape of the dome 100. The first flow regulator 20 may be provided directly in the inner inlet opening 5 or upstream in a connecting first pipe 21 feeding water to the inner inlet opening 5.

The water saving nozzle 1 also comprises an outer chamber 15 in the housing 10. An outer inlet opening 16 for water is provided in a first end 17 of the outer chamber 15. The outer inlet opening 16 may be provided at the top or in the vicinity of the top of the first end 17 of the chamber 15. The water may enter in a direction parallel to the central axis 3 or, for example, orthogonally to the central axis 3. In case the water comes in orthogonally to the central axis 3 it may enter radially or displaced, in a more tangential manner.

The outer chamber 15 is provided around the inner chamber having a wall 25 of the housing 10 in between. Preferably, also the outer chamber 15 is cylindrical in shape thus having a circle shaped cross-sectional area where the wall 25 of the inner chamber 2 is in the centre of the outer chamber. In a preferred embodiment, the outer chamber 15 and the inner chamber 2 are concentric. In the shown example, the housing is provided with threads 24 on its outer surface to ease attachment in a water tap or shower head. However, many other attachment possibilities are conceivable, such as snap attachment, bayonet joint and so on.

In a second end 19 of the outer chamber 15 several discharge openings 18 are provided for discharging the water in a spray 200. Preferably, the several discharge openings 18 are provided surrounding the inner discharge opening 6, for example, in a circle. The number of outer discharge openings 18 may be 10-20. The total cross-sectional area of the outer discharge openings 18 will influence the spray experience. Under normal conditions, the smaller the total area in comparison to the cross-sectional area of the outer inlet opening 16 the harder the spray jets will appear, unless the total area of the outer discharge openings 18 are too small and turn the discharged water into a mist.

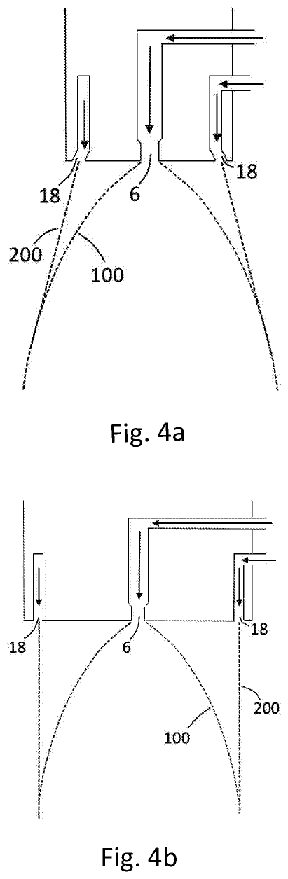

According to an embodiment the spray 200 is arranged to touch the outer diameter of the dome 100 in order to integrate with the dome 100 and thus boost the shower with a higher flow of water without changing the overall experience of the shower. In order to fulfil this aim, the outer discharge openings 18 can be angled outwardly in case they are situated closer to the inner discharge opening 6 compared to the outer diameter of the dome 100, as can be seen in FIG. 4a. In FIG. 4b another embodiment is shown where the outer discharge openings 18 are situated at a distance which more or less coincide with the outer diameter of the dome 100. In this embodiment the outer discharge openings 18 do not need to be angled. Thus, depending on the radial distance between the outer discharge openings 18 and the inner discharge opening 6 compared to the outer diameter of the dome 100 a desired angle can be decided so that the spray 200 will be directed to touch the outer diameter of the dome 100.

It is preferred to have a second flow regulator 22 in fluid connection with the outer inlet opening 16 in order to regulate the flow and pressure in the outer chamber 15. The second flow regulator 22 may be provided directly in the outer inlet opening 16 or upstream in a connecting second pipe 23 feeding water to the inner outer opening 16.

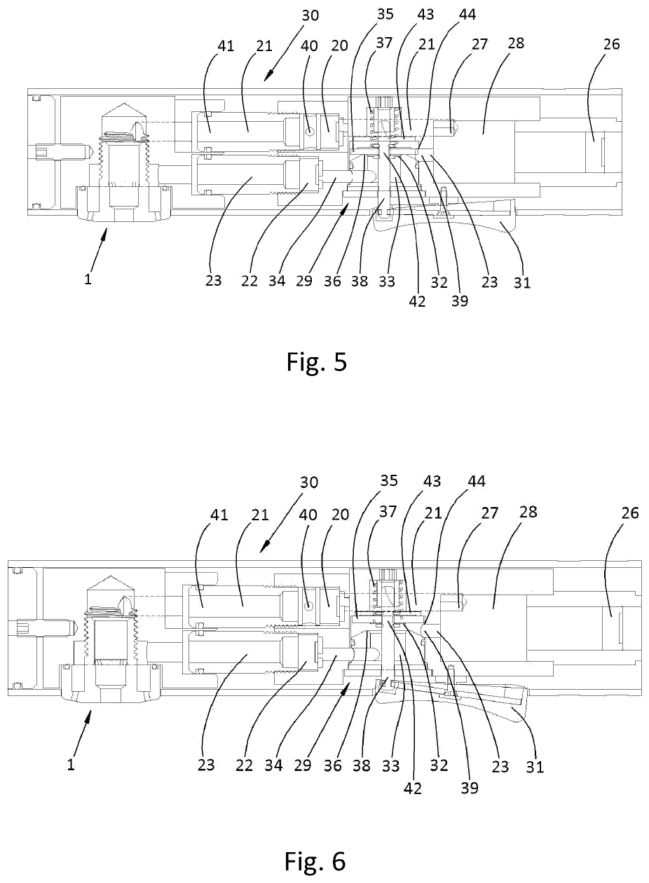

As previously mentioned, the present water saving nozzle 1, described in different embodiments above, is preferably provided in a shower head. In FIGS. 5 and 6 features of an embodiment of a shower head 30 is shown. Obviously, different embodiments are conceivable. In the shown embodiment a shower head suitable for holding in a user's hand is shown. It is also possible to arrange a fixed shower head above a user in a shower or bathtub or fixed in the ceiling. In the fixed embodiments it could be suitable to feed the water into the inner chamber 2 and the outer chamber 15 in parallel with the central axis 3. A person skilled in the art can rearrange the ingoing features and details in accordance with this. The described embodiments are not to limit the scope of the invention. The scope is limited by the appended claims.

In FIGS. 5 and 6 an embodiment is shown having a valve solution providing the possibility to operate the water saving nozzle in two different modes. A first mode gives a dome shaped discharge of water and the second mode gives a combination of a dome shaped 100 discharge of water and a spray 200 of water outside of the dome 100. FIG. 5 shows the first mode and FIG. 6 shows the second mode.

Following the flowing water, water is fed into the shower head 30 and reaches a main flow regulator 26 provided therein. For example, the main flow regulator 26 may regulate the flow to 6-12 l/min, preferably 8-10 l/min. This will stabilise the function of the shower head and its water saving nozzle 1.

The water thereafter flows in a common pipe 28 and then divides up into a first pipe 21 leading to the inner chamber 2. A first flow regulator 20 is in the shown embodiment positioned between a first end 27 of the first pipe 21 and the inner inlet opening 5. Preferably, the first flow regulator 20 gives a flow of 3.5-4 l/min. The flow of water through the first pipe 21 is always present, as long as feeding water from the water system is turned on to the shower head 30. This is the first mode where water flows to the inner chamber 2 and discharge as a dome 100.

In the second mode water also flows through a second pipe 23 between the common pipe 28 and the outer inlet opening 16. In the shown embodiment a second flow regulator 22 is present in the second pipe 23. Preferably, the second flow regulator 22 gives a flow of 3.5-4 l/min. Obviously, the main, first and second regulators depend on each other and the given examples are just an example. Any kind of suitable stop 29 is provided for closing and opening of the second pipe 23 in order to be able to switch between the first and second mode. This could be a valve for example. Preferably, a switch button 31 or any other switching device is provided for manual switching between the first mode and the second mode.

An embodiment of a valve solution will now be described for providing an advantageous switching function between the first and the second mode. In FIG. 5 the shower head 30 is in the first mode and the second pipe 23 is closed by means of a stop 29. In this embodiment the stop 29 is a valve 32 having a valve chamber 33 in fluid connection with a second portion 34 of the second pipe 23 downstream the valve 32. In the first mode a valve plunge 42, comprising a valve disc 35 in this shown embodiment, close against a valve seating 36 so that water cannot enter the valve chamber 33. A spring 37 bias the valve plunge 42 towards the valve seating 36. Centrally in the valve plunge 42, in the shown disc 35, a valve rod 38 is present, which valve rod 38 may be displaced along its length axis, bringing the valve plunge 42 between a closed position (as shown in FIG. 5) and an open position (as shown in FIG. 6). In the shown embodiment the valve disc 35 is attached to the valve rod 38, which brings the valve disc 35 with it between the two positions. The valve rod 38 may be controlled by means of, for example, a switch button 31.

In FIG. 6 the switch button 31 is pushed in which in turn displace the valve rod 38 and the valve disc 35 against the force of the spring 37 so that the valve plunge 42 is displaced from the valve seat 36 and the valve is open. Water will now be able to flow from a first portion 39 of the second pipe 23 into the valve chamber 33 and further through the second pipe 23 into the outer chamber 15.

In a special embodiment of the valve solution a balancing of forces is applied and a special function keeping the valve in an open position without the need of further need to push the switch button 31 after the initial pressing of the button is provided. This is accomplished by the following features. In the closed position, see FIG. 5, in order to be able to reduce the force needed from the spring 37, a leakage through a slit 44 of incoming water from the first portion 39 of the second pipe 23 is allowed into a cavity 43 at the spring 37 side of the valve plunge 42, in the shown case the valve disc 35. The slit 44 is preferably provided in a wall in the valve 32 so that when the valve plunge 42 is in the closed position against the valve seat 36 the valve plunge 42 will not seal the cavity 43 and therefore water will leak into the cavity 43 and fill it from the incoming water of the first portion 39. This builds up a pressure on the spring side of the valve plunge 42 helping the spring 37 to keep the valve plunge 42 in a closed position. When the switch button 31 is pushed in to go over to the open position, the valve plunge 42 leaves the valve seat 36 and thus let water to flow into the valve chamber 33. Since the second flow regulator 22 is situated after the valve chamber 33 and with the incoming flow, pressure will build up in the valve chamber 33, which will force the valve plunge 42 towards the open position. Since the force of the spring 37 is reduced, the built-up pressure will keep the open position in a stable manner.

Additionally, or instead of the slit 44 embodiment described above, it is possible to further work with the balancing forces by dimensioning the cross sectional area on the valve chamber 33 side of the valve plunge 42 in relation to the cross sectional area of the cavity 43 on spring side of the valve plunge 42. Thus, the force needed to push the switch button 31 into the open position or back to the closed position, for those embodiments having the feature that the switch button 31 stays in the open position, can be dimensioned by the relation between the cross sectional areas. For example, a larger cross sectional area of the valve plunge 42 compared to the cross sectional area of the valve chamber 33 will in the open position further enhance the open position and thus a higher force is needed to push the switch button 31 to the closed position.

In one embodiment the pressure on the spring side of the valve plunge 42 is further reduced when the valve is in the open position due to a fluid connection 40 between the cavity 43 on the spring side of the valve plunge 42 and a second portion 41 of the first pipe 21 being situated downstream the first flow regulator 20. This will create a suction force which will further help the valve plunge 42 to stay in the open position.

Preferably, the force of the spring 37 is strong enough to always close the valve when the water fed from the system is turned off.

The shower head 30 may also comprise a check valve in its inlet end to stop water from leaking back into the system as well as a filter in order to stop any debris in the water to get into the shower head.

The embodiments described above may be altered in many ways as can be understood by the description. Some of the exemplified flows are suitable for systems having a system pressure of 1.5-4.5 bar, preferably 2.5-4.5 bar and at least a water flow of 7 l/min in the system. Further adjustments are suitable in order to achieve the desired shapes or discharged water if the system pressure and flow is in other ranges.

1. A water saving nozzle, preferably for showers, comprising a housing having one inner chamber with an inner inlet opening for water to enter the inner chamber in a first end and one inner discharge opening for water leaving the inner chamber in a second end, the inner chamber having a central length axis going between the first end and the second end, and
an outer chamber with an outer inlet opening for water to enter the outer chamber in a first end and several outer discharge openings for water leaving the outer chamber in a second end, the outer chamber surrounding the inner chamber, around the central axis thereof,
the inner chamber comprises a water rotating device,
the inner discharge opening is large enough to avoid the formation of a mist or uncontrolled discharge of water,
wherein water is flowable through the inner inlet opening, through the inner chamber, through the water rotating device and through the inner discharge opening, being centrally provided, forming one dome shape of composed, discharged water; and
water is flowable through the outer inlet opening, through the outer chamber and out through the several outer discharge openings provided around the inner discharge opening, forming a spray of water surrounding the dome shape from the inner discharge opening.

2. The water saving nozzle according to claim 1, wherein a first flow regulator is in fluid contact with the inner chamber and a second flow regulator is in fluid connection with the outer chamber.

3. The water saving nozzle according to claim 1, wherein the outer discharge openings are directed so that the spray will touch an outer diameter of the dome shaped water from the inner discharge opening.

4. A shower head, comprising a water saving nozzle according to claim 1, having a first pipe feeding water to the inner chamber from a water system and a second pipe feeding water to the outer chamber from the water system, wherein the second pipe is provided with a stop for closing and opening of the flow of water through the second pipe towards the outer chamber, providing a first mode giving a dome shaped water discharge when the stop is in a closed position, closing the second pipe, and a second mode giving a combined dome and spray water discharge when the stop is in an open position, opening the second pipe.

5. The shower head according to claim 4, wherein the stop is a valve comprising a valve chamber in fluid connection with a second portion of the second pipe downstream the valve, a valve plunge comprising a valve rod, and a cavity, on an opposite side of a valve disc to the valve chamber, comprising a spring for keeping the valve in a closed position, where the valve plunge stops any flow towards the outer chamber.

6. The shower head according to claim 5, wherein the valve is toggled between the two modes via a switch button connected to the valve rod for movement of the valve plunge.

7. The shower head according to claim 5, wherein the valve in the second mode is in an open position letting water to flow from a first portion of the second pipe into the valve chamber and further to the outer chamber.

8. The shower head according to claim 5, wherein a slit is provided between a first portion of the second pipe and the cavity so that a leakage of water will enter the cavity when the valve is in the first mode, i.e. in the closed position, giving a rise in water pressure in the cavity further keeping the valve plunge in closed position.

9. The shower head according to claim 5, wherein the second flow regulator is arranged downstream the valve in the second portion of the second pipe so that when the valve is in the open position a pressure is built up in the valve chamber keeping the valve plunge in the open position after the switch button is pushed.

10. The shower head according to claim 5, wherein a fluid connection is provided between the cavity and a second portion of the first pipe, wherein the second portion runs between the first regulator and the inner chamber.
